(19) United States
(12) Patent Application Publication
(10) Pub. No.: US 2010/0182334 A1
(43) Pub. Date: Jul. 22, 2010

(54) METHOD AND SYSTEM FOR IMPROVED DISPLAY OF SAMPLED DATA DIFFERENCES

(75) Inventors: John Peter Francis Jefferies, Cheshire (GB); Ian David White, Cheshire (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/691,467

(22) Filed: Jan. 21, 2010

Related U.S. Application Data
(60) Provisional application No. 61/146,538, filed on Jan. 22, 2009.

(51) Int. Cl. G09G 5/02; H04N 1/60

(52) U.S. Cl. 345/589; 358/1.9

(57) ABSTRACT

A method of comparing a first raster to a second raster includes determining, for pairs of corresponding regions (for example, individual pixels) of the first raster and second raster, a comparison value between the corresponding regions of the first and second raster. For each comparison value, a color code is assigned based on a value of the comparison value. A comparison raster is generated from the color-coded comparison values. The comparison raster is presented to a reviewer.

### CROSS-REFERENCE TO RELATED APPLICATIONS

This application claims the benefit under 35 U.S.C. §119(e) of U.S. Provisional Patent Application Ser. No. 61/146,538 filed on Jan. 22, 2009, which is incorporated herein by reference.

### FIELD

The present invention is directed to the area of methods and systems for comparing data, for example, comparing data in rasters. The present invention is also directed to methods and systems for printing documents, including methods and systems for allowing a user to compare rasters of the documents.

### BACKGROUND

Test and evaluation processes for a variety of functions provide that two sets of sampled data be compared and the comparison displayed to a user to visually assess differences. For example, in two-dimensional (2D) imaging this is of use for scanners, renderers and any other technology that produces or manipulates raster data. The visual display of the results of the comparison should enable the viewer to identify both large and small differences quickly and easily. Existing methods, such as showing all differences as a single color, e.g. black, or showing the scale of differences as a tone value, can make it difficult to see small differences, or difficult to distinguish large differences from small ones.

For example, a raster representing ‘correct’ output from some process, such as a RIP (raster image processor), can be compared to another a raster that may or may not be a correct copy of the first. If the two rasters are slightly different this does not mean that one of them is incorrect. An easy method of determining the area(s) of the rasters that differ can be helpful in analyzing those differences.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram illustrating one embodiment of a system for comparing data, such as raster data, according to the invention; and

FIG. 2 is a flowchart of one embodiment of a method of comparing data, such as raster data, according to the invention.

### DETAILED DESCRIPTION

The present invention is directed to the area of methods and systems for comparing data, for example, comparing data in rasters. The present invention is also directed to methods and systems for printing documents, including methods and systems for allowing a user to compare rasters of a document.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of computing device, such as a computer or printer, that includes a processor or any combination of computing devices where each device performs at least part of the process.

Suitable computing and printer devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication between devices can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

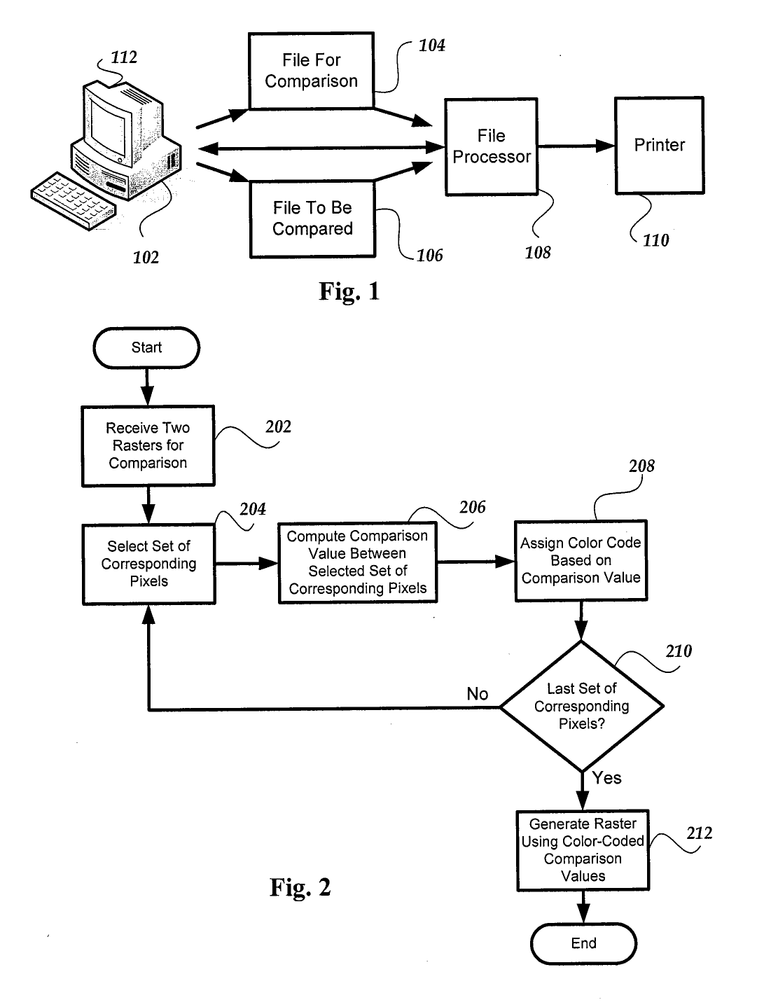

FIG. 1 illustrates one embodiment of a system for comparing documents. A computer 102 generates or stores a data file 104 (e.g., a raster image) that is to be compared against a second data file 106 (e.g., a second raster image) that also may be generated or stored on the computer or provided from any other suitable source. The computer 102 includes a display 112. Both data files 104, 106 are provided to a file processor 108. The result of the comparison of the data files is presented to the user on a printer 110 or computer display 112 or any other suitable device for viewing the comparison. The file processor 108 can be, at least in part, included with the printer 110, or on the computer 102.

Two data files 104, 106 can be compared and the results displayed visually for a viewer to analyze. For example, two rasters may be compared to assess quality of the rasters. The quality may be assessed for changes over time or, for example, when software or hardware changes are made. The comparison of the rasters may indicate that the quality of the raster has improved or may indicate difference that are unimportant or expected or may indicate unwanted differences. Rasters made using different raster software may also be compared to select a software product. Comparison of rasters may also be used in software/hardware development to assess software/hardware changes or to identify areas in which a software product does or does not emulate another product.

As an example of the comparison, two rasters can be compared and the results visually displayed using a color scale that indicates the difference (or some other comparative measure) between corresponding pixels, or other regions, of the rasters. This may be particularly useful when comparing rasters that should be the same or substantially similar. The visual display of a “comparison raster,” which includes color-coded pixels representing the difference (or some other comparative measure) between pixels, or other regions, of the original two rasters, can be used to identify portions of the original rasters that will appear visually different to a viewer (e.g., where the color, tone, brightness, rate of change of any of the aforementioned attributes, or any combination thereof are visibly different).

FIG. 2 is a flowchart illustrating one embodiment of a method of comparing two rasters. It will be recognized that this method may be applied or adapted to other types of data files. The system receives two rasters for comparison (step 202). One or both rasters may be generated by the system. Alternatively or additionally, one or both rasters may be received from an external source using any suitable technique including wired or wireless transmission or providing the raster(s) using any suitable storage medium.

A set of corresponding pixels from the two rasters is selected (step 204). Alternatively, larger sets of data are selected for comparison; for example, a block of pixels.

A comparison value is derived or computed representing the difference (or some other comparative measure) between corresponding pixels (or other sets of data) in the two rasters (step 206) and is converted from that comparison value to a color code (step 208). Each color code represents a range of comparison values. This is repeated for each corresponding set of pixels (or other sets of data) until all of the pixels (or sets of data) have been processed (step 210). Alternatively, only a portion of the rasters is processed in this manner.

A raster (e.g., a “comparison raster”) is generated or formed by setting a corresponding pixel in the new raster to the color code for the comparison value, and that raster is presented to the user (step 212). The “comparison raster” can be displayed on the display 106 or printed on the printer 108, or both, for comparison by the user.

In at least some embodiments, two rasters are to be compared. If necessary or desired, they are transformed such that they have the same dimensions, color depth, channel count (e.g., the number of different inks or colorants used to print the rasters), resolution, or any combination thereof.

As an example of obtaining a comparison value, for every pixel of the raster, the color values of that pixel are read from each raster and compared. Comparisons may be made in device code values per colorant, in delta-E, or in any other coordinate space that is appropriate for the data in question (e.g., decibels for audio data). Comparisons may be made based on one or more different characteristics, such as color, tone, brightness, rate of change of any of the aforementioned attributes, or any combination thereof.

In at least some embodiments, a single “comparison value” is derived for every pixel. As an example, the “comparison value” may represent differences in a single channel (e.g., a single colorant such as black, cyan, magenta, or yellow), color differences that would be apparent to a human observer, the maximum device code difference (e.g., the difference in device code between full coverage for a colorant and no coverage for a colorant) for any channel (e.g., colorant), or any other computation deemed appropriate or desirable.

In at least some embodiments, the comparison value is used to select a “representation color” from a look-up table or by using an algorithm. In one embodiment, if the range of comparison values is normalized to a scale of 0-100. In this embodiment, the representation color for a comparison value of 0 is white, the representation color for comparison values from 1 to 20 is yellow, for comparison values of 21-40 the color is orange, for comparison values of 41-60 the color is red, etc. It will be recognized that other patterns of color (e.g., a comparison value of 0 is black) and other ranges of comparison values (e.g., a comparison value of 0-10 is white) can be used.

In at least some embodiments, a ‘result raster’ with the same dimensions as the two rasters being compared is then constructed or generated. For every pixel (or other set of data) in the source rasters, the pixel in the result raster is filled with the representation color appropriate for the comparison value of that pixel. The result raster is then presented (e.g., displayed or printed) to the user.

In at least some embodiments, the user is provided with options to amend the number and size of the ranges used to select a representation color from a comparison value, or to amend the representation colors to be used for each range.

In at least some embodiments, the comparison method for the two images may be selected by the user (e.g. switching from a “maximum device code value for any colorant” to a “delta-E” comparison).

The use of colors to represent ranges of comparison values can enable the user to see even very small differences between the two rasters (something that may be difficult if the difference is represented simply as a grayscale value), while simultaneously being able to distinguish between small and large differences (something that often can't be done easily if the difference is represented as a black and white image).

Outside of 2D imaging the same technology may be used to compare any other data set that may be represented as a two-dimensional map. Thus sampled audio data may have the dimensions of frequency and time, and the value of each sample may represent amplitude. For the purposes of this description terminology suitable for 2D imaging is used, but that is not intended to be exclusive.

It will be understood that each block of the flowchart illustration in FIG. 2, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of comparing a first raster to a second raster, the method comprising:
for each of a plurality of pairs of corresponding regions of the first raster and the second raster, determining a comparison value between the corresponding regions of the first and second rasters;
for each comparison value, assigning a color code based on a value of the comparison value;
generating a comparison raster using the color-codes for the comparison values; and
providing the comparison raster to a reviewer.

2. The method of claim 1, wherein the corresponding regions comprise single pixels.

3. The method of claim 1, wherein determining the comparison value comprises determining a difference in a characteristic of the region of the first raster and the region of the second raster.

4. The method of claim 3, wherein determining the difference comprises determining a color difference between the region of the first raster and the region of the second raster.

5. The method of claim 3, determining the difference comprises determining a difference in a single colorant channel between a region of the first raster and a corresponding region of the second raster.

6. The method of claim 3, wherein the characteristic is selected from color, tone, or brightness.

7. The method of claim 3, wherein the characteristic is a rate of change of at least one of color, tone, or brightness.

8. The method of claim 1, wherein assigning a color code comprises assigning the color code based on the value of the comparison value using an algorithm.

9. The method of claim 1, wherein assigning a color code comprises assigning the color code based on the value of the comparison value using a look-up table.

10. The method of claim 1, wherein determining a comparison value comprises determining the comparison value for every pair of corresponding pixels of the first and second rasters.

11. The method of claim 1, wherein providing the comparison raster to the reviewer comprises displaying the comparison raster on a video display.

12. The method of claim 1, wherein providing the comparison raster to the reviewer comprises printing the comparison raster.

13. A system for comparing rasters, comprising:
at least one processor; and
a computer readable storage medium having processor-executable instructions, the processor-executable instructions when installed onto the system enables the at least one processor to perform actions, comprising:
for each of a plurality of pairs of corresponding regions of the first raster and the second raster, determining a comparison value between the corresponding regions of the first and second rasters;
for each comparison value, assigning a color code based on a value of the comparison value;
generating a comparison raster using the color-codes for the comparison values; and
providing the comparison raster to a reviewer.

14. The system of claim 13, further comprising a computer coupled to the at least one processor and configured and arranged to store the first and second rasters.

15. The system of claim 13, further comprising a printer coupled to the computer and the at least one processor.

16. The system of claim 15, wherein the printer comprises at least one of the at least one processors.

17. The system of claim 15, wherein the computer comprises at least one of the at least one processors.

18. A computer readable storage medium having processor-executable instructions, the processor-executable instructions when installed onto a system enable the system to perform actions, comprising:
for each of a plurality of pairs of corresponding regions of the first raster and the second raster, determining a comparison value between the corresponding regions of the first and second rasters;
for each comparison value, assigning a color code based on a value of the comparison value;
generating a comparison raster using the color-codes for the comparison values; and
providing the comparison raster to a reviewer.

19. The computer readable storage medium of claim 18, wherein determining the comparison value comprises determining a difference in a characteristic of a region of the first raster and a corresponding region of the second raster.

20. The computer readable storage medium of claim 18, wherein determining a comparison value comprises determining a comparison value for every pair of corresponding pixels of the first and second rasters.
